(19) United States
(12) Patent Application Publication
(10) Pub. No.: US 2019/0295123 A1
(43) Pub. Date: Sep. 26, 2019

(54) EVALUATING MEDIA CONTENT USING SYNTHETIC CONTROL GROUPS

(71) Applicant: Free Stream Media Corporation d/b/a Samba TV, San Francisco, CA (US)

(72) Inventors: Bonnie Rose Magnuson-Skeels, San Francisco, CA (US); Christopher Carl Squire, San Francisco, CA (US); Joshua James Miller, San Francisco, CA (US)

(21) Appl. No.: 15/935,979

(22) Filed: Mar. 26, 2018

(51) Int. Cl. G06Q 30/02; G06F 17/30

(52) U.S. Cl. CPC G06Q 30/0246; G06F 17/30876; G06F 17/30867; G06F 17/3053

(57) ABSTRACT

Approaches provide for evaluating lift associated with supplemental content based on a synthetic exposure event. Users may be separated into groups of exposed users that have interacted with supplemental content and an unexposed group that has not interacted with the supplemental content. Users within the unexposed group may be ranked and sorted into a subset control group. The subset control group may be presented with synthetic exposure events that monitor conversions for the supplemental content in the same manner as the exposed group. Thereafter, conversion rates may be compared to determine the impact of the supplemental content.

### BACKGROUND

Consumers often receive various types of information while consuming media content, such as by watching television or movies or listening to music. The information may be interspersed throughout the content, such as via product placement, or may be presented during breaks in the content. Content providers attempt to target the information to certain demographics and often choose certain media content to deploy in campaigns. Unfortunately, the providers have difficulty anticipating the impact of their information. While a provider may notice a change, such as an increase in sales or clicks for advertisements (which may be referred to as conversions), the provider often does not know how much of the increase is the result of the campaign. As such, content providers may take a broad approach to deploying campaigns, which may be inefficient.

### BRIEF DESCRIPTION OF THE DRAWINGS

Various embodiments in accordance with the present disclosure will be described with reference to the drawings, in which:

FIG. 1A illustrates an example environment in which aspects of the various embodiments can be utilized;

FIG. 1B illustrates an example environment in which aspects of the various embodiments can be utilized;

FIG. 1C illustrates an example environment in which aspects of the various embodiments can be utilized;

FIG. 2 illustrates an example system for generating synthetic exposure events in accordance with various embodiments;

FIG. 3 illustrates an example system for generating synthetic exposure events in accordance with various embodiments;

FIG. 4 illustrates an example system for determining a potential exposure score in accordance with various embodiments;

FIG. 5 illustrates an example system for determining a control group in accordance with various embodiments;

FIG. 6 illustrates an example system for generating synthetic exposure events in accordance with various embodiments;

FIG. 7 illustrates an example process for generating synthetic exposure events in accordance with various embodiments;

FIG. 8 illustrates an example process for comparing conversion rates in accordance with various embodiments;

FIG. 9 illustrates an example process for comparing conversion rates in accordance with various embodiments; and

FIG. 10 illustrates an example system for displaying content, in accordance with various embodiments.

### DETAILED DESCRIPTION

Systems and methods in accordance with various embodiments of the present disclosure may overcome one or more of the aforementioned and other deficiencies experienced in conventional approaches to controlling playback of media content. In particular, various approaches provide for using a voice communications device to control, refine, or otherwise manage the playback of media content in response to a spoken instruction.

In various embodiments, user devices such as televisions, monitors, wearable devices, smartphones, tablets, handheld gaming devices, and the like may include display elements (e.g., display screens or projectors) for displaying consumer content. This content may be in the form of television shows, movies, live or recorded sporting events, video games, and the like. Content displayed on these devices may be interspersed with supplemental content, such as advertising. In various embodiments, the supplemental content may attempt to induce a user into purchasing an item, navigating to a website, watching other content, or the like. Content providers may attempt to target or otherwise direct their supplemental content, which may also be referred to as targeted content, to particular users or demographics. This may be accomplished by associating targeted content with particular media content. For example, content providers may receive information that a certain demographic, say individuals in the 40-60 age range, predominantly watch cable news networks. Accordingly, the content provider may direct targeted content toward that demographic via cable news networks, rather than children's shows that may not often be watched by that demographic. However, content providers may have trouble predicting the likelihood of success for targeted content or measuring the success of a previous roll out of targeted content. Accordingly, systems and methods of the present disclosure are directed toward developing synthetic control groups. Synthetic control groups may enable content providers to better determine the effectiveness of their targeted content or supplemental content, which may lead to improved strategies to more efficiently deploy resources.

In various embodiments, a user device may include an embedded chipset utilized to identify content being displayed on the user device, which may be referred to as Automatic Content Recognition (ACR). The chipset may be utilized to receive the content feed being transmitted to the user device, for example a live TV feed, a streaming media feed, or feed from a set top cable box. Furthermore, in various embodiments, the chipset may extract or otherwise identify certain frames from the media stream for later processing and recognition. Identification may be facilitated by using a fingerprint made up of a representation of features from the content. For example, software may identify and extract features and compress the characteristic components into a fingerprint thereby enabling unique identification. In various embodiments, a one-way hash may be utilized in the generation of the fingerprint. This fingerprint may then be compared with a database of content to facilitate recognition. This database may include feature vectors and/or machine learning techniques to facilitate robust, quick matching. The recognition of content may be performed by a remote server or by the user device itself if it has sufficient processing capability and access to a content database. It should be appreciated that multiple fingerprints may also be utilized in the identification process. ACR may further be utilized to identify targeted content associated with the other media content being consumed by the user. Accordingly, the timing of targeted content may be correlated with the associated content, thereby providing valuable information to content providers regarding which media content is consumed along with their targeted content.

While various embodiments include an embedded chipset for generating fingerprints and performing ACR, in other embodiments fingerprint generation and ACR may be performed without an embedded chipset. For example, fingerprint generation and ACR may be performed by a software application running on the user device. As another example, fingerprint generation and ACR may be performed utilizing an application that may include software code stored on a second user device. For example, if a user were watching content on a television the user may incorporate a second user device, such as a smartphone, to take an image or video of the screen or receive a portion of audio from the content. Thereafter, the image, video, or audio content may be utilized similarly as described above to identify the content displayed on the screen.

In various embodiments, users may be identified and divided into different groups based on their consumption of content, particularly their exposure to supplemental content. As used herein, exposure refers to a user seeing or otherwise experiencing supplemental content. It should be appreciated that exposure may be particularly defined based on the content provider or the type of supplemental content. For example, in various embodiments exposure may refer to a certain period of time that the supplemental content is viewed (e.g., 5 seconds, 10 seconds, 20 seconds, etc.). Additionally, in various embodiments, exposure may also be correlated to whether or not a user navigated away from the media content when the supplemental content was presented. By utilizing ACR as described above, the user's viewing habits and associated exposure may be determined, as well as which supplemental content the user was exposed to. Accordingly, once exposure has been confirmed, the user's browsing or buying habits may be monitored in order to determine whether a conversion has occurred. As used herein, conversion may refer to navigation to a website, purchasing a product, viewing certain content, or the like, and may also include in-person store visits and purchases. Furthermore, conversion may be defined within a time period, such as within a week of viewing the supplemental content, a day, or the like. Additionally, conversion may be recorded with respect to a number of exposures to the supplemental content. That is, the number of times the user is exposed to the supplemental content may be tracked up to and until conversion.

Tracking conversion for users that are exposed to supplemental content may assist content provider to better direct or otherwise deploy their supplemental content. However, there are many users who may not have been exposed to the supplemental content, but who may nevertheless undergo a conversion event. These users may share one or more characteristics with the exposed users, such as demographic information, interests in particular types of content, or the like. As such, it is desirable to evaluate conversions for users that were not exposed to the supplemental content, but are similar to those that were exposed, to determine the effectiveness of the supplemental content, which may be referred to as lift. In various embodiments, users may be classified as unexposed. In other words, the users may not have viewed the supplemental content. However, these unexposed viewers may be classified by the likelihood of viewing the content or their potential exposure, which may be based at least in part on previous viewing history. The unexposed viewers may be ranked, based on the likelihood of their potential exposure, and thereafter a control group may be selected from the ranked list. It should be appreciated that the control group may be any size or percentage relative to the ranked list.

In various embodiments, the control group may be used to perform synthetic exposure events based on the control group's viewership history. For example, a period of time may be specified to monitor for certain conversion events, such as navigating to a website. Thereafter, the conversion for the users may be monitored within a similar time period of the exposed group. The conversion rates may be compared between the two groups to determine the difference in conversion rates between the control group and the exposed group. It should be appreciated that the difference may be representative of the true lift that can be associated to the supplemental content. That is, a difference in conversion rates between the exposed group and the control group is more representative of the content provider's success than a difference in conversion rates between the exposed group and the general population. By evaluating the groups (e.g., exposed and control) under similar conditions (e.g., definition of conversion, time period, etc.) the effects of the supplemental content are effectively normalized to determine what type of impact, or lift, exposure to the supplemental content drives.

In various embodiments, inadvertent or other exposures may be evaluated. For example, a user's browsing history may be tracked and the presence of additional exposures (which may be referred to as touches) may be recorded. Accordingly, users within the control group who receive exposure from other sources, such as digital media on a second screen, may be removed from the control group. Further, users that are subject to more touches may be removed or otherwise evaluated to determine the lift associated with additional touches. By incorporating exposure from other sources, systems and methods of the present disclosure are better suited for evaluating lift in an age where users may receive exposure from many different sources.

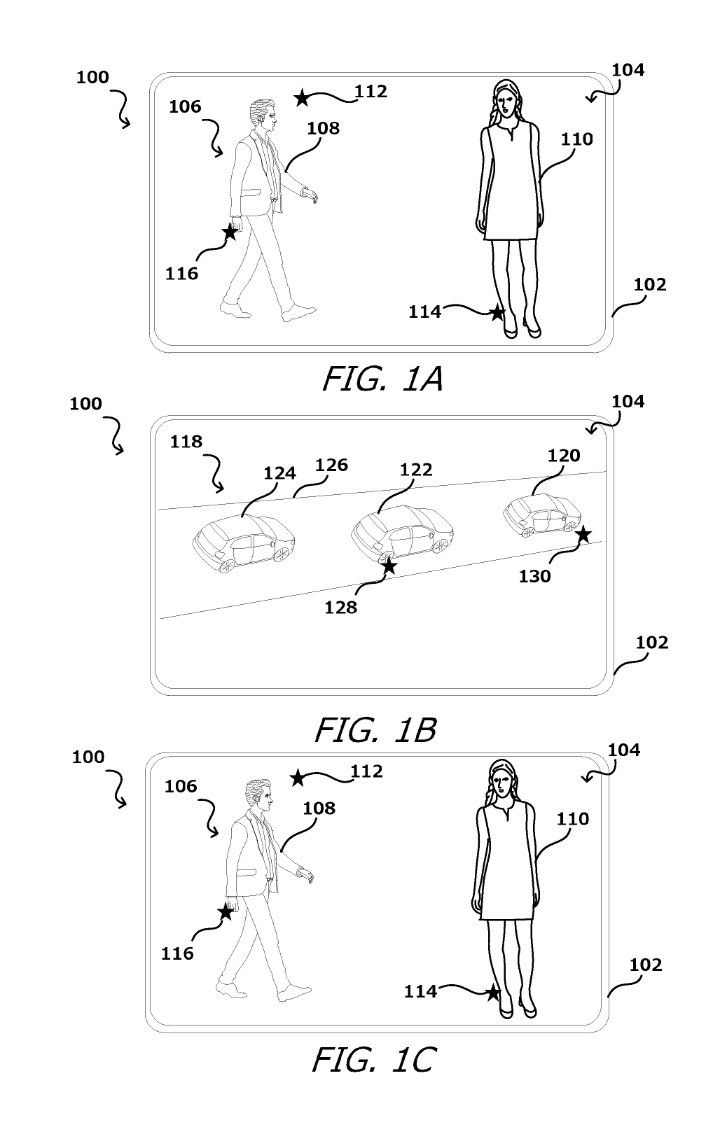

FIG. 1A illustrates an example environment 100 including a user device 102 having a display 104 that includes rendered content 106. It should be appreciated that, in various embodiments, the user device 102 may include one or more video processing components in order to render the content 106. However, in various embodiments, the content 106 may merely project or display content that is rendered by another device. The devices 102 can include, for example, portable computing device, notebook computers, ultrabooks, tablet computers, mobile phones, personal data assistants, video gaming consoles, televisions, set top boxes, smart televisions, portable media players, and wearable computers (e.g., smart watches, smart glasses, bracelets, etc.), display screens, displayless devices, other types of display-based devices, smart furniture, smart household devices, smart vehicles, smart transportation devices, and/or smart accessories, among others. The illustrated scene is a first person 108 walking toward a second person 110. However, it should be appreciated that the illustrated scene is by way of example only and the content may include any type of content, such as television programming, online videos, video games, audio playback, and the like. The rendered content 106 includes a plurality of characteristics 112, 114, 116 arranged at different locations. The characteristics 112, 114, 116 may include settings associated with the image/video scene, such as hue, color, luminosity, saturation, contrast, audio quality levels, and the like. As described above, the characteristics 112, 114, 116 may be utilized to generate a fingerprint for ACR to recognize and log the content being viewed by the user. As also described above, fingerprints may be generated from multiple scenes (e.g., at different points of the content playback) of the content, which may improve the accuracy of ACR It should be appreciated that the characteristics 112, 114, 116 are for illustrative purposes only and may be located at different places in the scene. Alternatively, fingerprints may be embedded within the content and need not be generated from characteristics 112, 114, 116.

FIG. 1B illustrates the example environment 100 and the user device 102 having different rendered content 118 on the display 104. The illustrated different rendered content 118 may correspond to supplemental content. That is, content different than the media content originally consumed by the user. As shown in FIG. 1B, the different rendered content 118 is a commercial for an automobile, and shows three automobiles 120, 122, 124 travelling along a roadway 126. The different rendered content 118 also includes characteristics 128, 130 to facilitate identification of the content. As will be explained below, the identification of the different rendered content 118 may facilitate the determination that the user or household associated with the user device 102 has been exposed to the supplemental content. FIG. 1C illustrates the user device with the rendered content 106, which returns to the previously illustrated scene. The characteristics 112, 114, 116 are still associated with the rendered content 106 and may further be used to confirm the content on the display 104 and/or assign the user to a group, such as the exposed group.

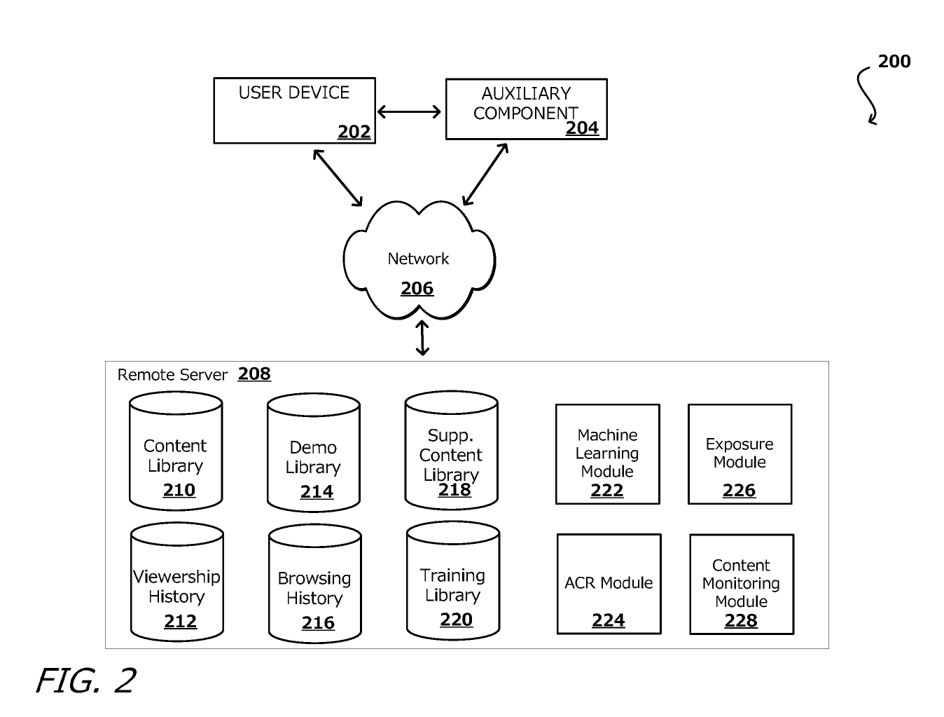

FIG. 2 illustrates an example system 200 for evaluating and determining exposures to certain types of content. In this example, the system 200 shows example data flows between a user device, a network, and associated components. It should be noted that additional services, providers, and/or components can be included in such a system, and although some of the services, providers, components, etc. are illustrated as being separate entities and/or components, the illustrated arrangement is provided as an example arrangement and other arranged as known to one skilled in the art are contemplated by the embodiments described herein. The illustrated system 200 includes the user device 202 and associated auxiliary components 204. As described above, the user device 202 may include a television, personal computing device, laptop, tablet computer, or any other type of device. Furthermore, the auxiliary components 204 may include surround sound speakers, sound bars, set top cable boxes, streaming service boxes, and the like. The illustrated embodiment, the user device 202 and/or the auxiliary components 204 may be in communication with a network 206. The network 206 may be configured to communicate with the user device 202 and/or the auxiliary components 204 via a wired or wireless connection. It should be appreciated that the network 206 may be an Internet or Intranet network that facilitates communication with various other components that may be accessible by the network 206.

The illustrated embodiment includes a remote sever 208, which may include a memory and processor for storing information and also executing written instructions, such as written instructions in a computer program. It should be appreciated that certain elements illustrated as associated with the remote server 208 may be arranged on a different server or memory bank. Further, the module and processes described may be executed by a hosting service, such as a “cloud” service, or by a virtualized server, rather than through dedicated servers or the like. The illustrated remote server 208 includes a content library 210. The content library 210 may include information regarding media content that may be consumed by the user via the user device 202. For example, the content library 210 may include information to enable the ACR techniques described above to identify content displayed on the user device 202. In various embodiments, the content library 210 includes content that may be from television broadcasts, set top boxes, streaming services, online videos, music services, video games, and the like. Furthermore, the content library 210 may be continuously updated and refined as new content is added to libraries, such as new series or video game releases.

In various embodiments, the remote server 208 further includes a viewership history database 212, which may be developed over a period of time by monitoring the content consumed via the user device 202, which may be facilitated through the use of the ACR techniques described above. The viewership history 212 may be on a household-by-household basis. That is, the viewership history 212 may be developed by evaluating content consumed that is associated with an IP addresses for a household or data access point. Additionally, in various embodiments, the viewership history 212 may be developed on a user-by-user basis (e.g., a user may sign into the user device 202) or on a device-by-device basis. Accordingly, the viewing habits of a user may be evaluated and saved within the database 212. For example, the viewership history 212 may include information directed to the specific content consumed (e.g., particular shows, movies, video games, etc.), the type of viewing (e.g., live, time-shifted, etc.), the source of the content (e.g., television antenna, cable services, satellite, streaming, etc.), temporal information (e.g., time of day, day of week, etc.), and the like. Accordingly, the viewing habits for households and the like may be tracked to determine whether the user is exposed to certain supplemental content, as will be described below.

The illustrated remote server 208 further includes a demographic library 214. The demographic library 214 may be directed toward the demographics of the household and/or user associated with the user device 202. For example, certain types of content, such as supplemental content, may be marketed differently based on demographics of the audience. Demographics may include age, gender, income, education, geographic location, and the like. By monitoring the demographics of the users associated with the user device 202, the supplemental content, and thereafter the synthetic exposures described herein, may be targeted to a very specific audience, thereby providing improved details to content providers. For example, a luxury car company may want to advertise to people having a certain income level and with a certain age bracket (e.g., older adults because teenagers would be unlikely to be able to purchase the vehicle). By knowing the demographics of the users, and the content they consume, supplemental content may be targeted to the media content consumed by the appropriate persons.

Additionally, in various embodiments, the remote server 208 includes a browsing history database 216. The browsing history database 216 may collect websites or other digital content accessed by the user, for example via a second user device. The browsing history may be correlated to an IP address, device identifier, cookies, supercookies, or other data or techniques which may allow secondary browsing to be tracked. For example, the browsing history may be utilized to monitor conversion events, such as navigating to a certain website after viewing supplemental content. Accordingly, conversions may be tracked on second screens and correlated to exposures from a different screen. The illustrated remote server 208 further includes a supplemental content 218. In various embodiments, the supplemental content library 218 may be incorporated into the content library 210. In other embodiments, the supplemental content library 218 may include supplemental content, which may be identified by the fingerprints as described above. Furthermore, the supplemental content library 218 may include information to enable identification of product placement or other embedded supplemental content within other content. As a result, each exposure to supplemental content may be monitored.

In various embodiments, one or more machine learning techniques may be utilized in order to identify supplemental content or refine identification techniques. The illustrated embodiment includes a training library 220, which may be used to train machine learning techniques, such as neural networks, associated with the machine learning module 222. In various embodiments, the machine learning module 222 may obtain information from the remote server 208 or various other sources. The machine learning module 222 may include various types of models including machine learning models such as a neural network trained on the media content or previously identified fingerprints. Other types of machine learning models may be used, such as decision tree models, associated rule models, neural networks including deep neural networks, inductive learning models, support vector machines, clustering models, regression models, Bayesian networks, genetic models, various other supervise or unsupervised machine learning techniques, among others. The machine learning module 222 may include various other types of models, including various deterministic, nondeterministic, and probabilistic models. In various embodiments, the machine learning module 222 is utilized to quickly categorize and identify content associated with the extracted information. Further, the machine learning module 222 may be utilized to separate users between exposed and unexposed groups, and further to assist in identification of the control group described above. The neural network may be a regression model or a classification model. In the case of a regression model, the output of the neural network is a value on a continuous range of values, which may represent exposure, likelihood of exposure, or the like. In the case of a classification model, the output of the neural network is a classification into one or more discrete classes.

In various embodiments, an ACR module 224 is incorporated into the remote server 208 in order to facilitate generation and identification of fingerprints. It should be appreciated that at least a portion of the ACR module 224, or the entire module 224, may be integrated into the user device 202, as described above. As such, content may be recognized as it is distributed to the user device 202. The illustrated remote server 208 further includes an exposure module 226. The exposure module 226 may track or otherwise identify which supplemental content the users have been exposed to, based at least in part on their viewing history. For example, the exposure module 226 may collect data corresponding to what is classified as an exposure. In various embodiments, exposure may be defined as a period of time that the supplemental content is viewed. Additionally, a quantity of supplemental content viewed, whether the entire supplemental content was viewed, and the like may further be utilized to define what constitutes an exposure. The exposure module 226 may communication with other portions of the remote server 208, such as the supplemental content library 218 and the ACR module 224, in order to identify supplemental content as they are presented on the user device 202 and further to monitor how the user reacts to the supplemental content. For example, the user fast forwarding through the supplemental content in an embodiment where the user is viewing the content in a time-shifted manner may not be classified as an exposure, based at least in part on the rules defined within the exposure module 226. Accordingly, the user's interaction with the supplemental content may be monitored. In various embodiments, the exposure module 226 may interact with a content monitoring module 228 in order to further monitor supplemental content. For example, the supplemental content module 228 may be utilized to monitor supplemental content or other exposures through secondary sources, such as a second screen via browsing history. This information may be transmitted to the exposure module 226 for processing. For example, users may be classified as exposed, even if they had not seen certain supplemental content during particular content, based on secondary interactions where an exposure event occurred. Accordingly, the remote sever 208 may be utilized to determine whether users have been exposed to certain supplemental content.

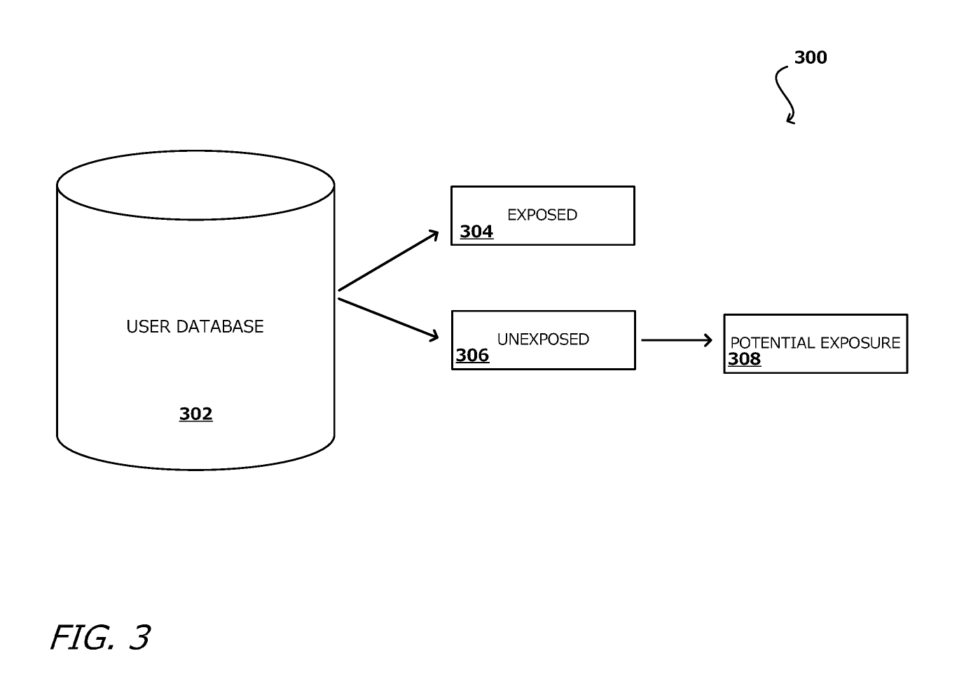

FIG. 3 illustrates an example system 300 for classifying users between exposed and unexposed categories. As used herein, exposed may refer to users that have interacted with or otherwise viewed supplemental content for a predetermined period of time. That period of time may be adjusted based on the supplemental content. For example, supplemental content that only lasts for 5 seconds may require a greater percentage of the supplemental content being viewed (e.g., 80 percent or 100%) compared to a longer, multi-minute supplemental content. Additionally, other types of interactions may be incorporated to define exposure, such as a user clicking on a link or utilizing another feature associated with the supplemental content. Furthermore, in various embodiments the supplemental content may be directed toward product placement or other more subtle forms, and as a result, multiple touches or exposures may be tallied in order to determine whether the user has been exposed to the supplemental content. As used herein, unexposed may refer to users that have not interacted with or otherwise viewed supplemental content. In various embodiments, users that are unexposed may be the users that are not part of the exposed category. However, different sets of rules or criteria may be established for unexposed users.

In the illustrated embodiment, the system 300 includes a user database 302, which may be a collection of users utilizing the service or a subset of those users. For example, the user database 302 may include each user that participates within the system to enable ACR within their user devices. However, because many supplemental content rollouts may be regional or targeted, the user database 302 may also be a subset (which is likely smaller than the total number of users) directed to users based on a predetermined criterion or multiple criteria. As illustrated, the users may be divided into categories, such as the illustrated exposed group 304 and the unexposed group 306. Accordingly, the subsequent conversion rates of these users may be evaluated separately and independently, which will provide a refined determination of the lift associated with the supplemental content. For example, the conversion rate of the users in the exposed group 304 may be compared to the conversion rate for the users in the unexposed group 306. If the conversion rates are substantially similar, it may be determined that the lift of the campaign was low. In other words, the supplemental content may have been ineffective. However, if the conversion rates are different, then it is likely that the difference may be attributed to the supplemental content. Furthermore, in various embodiments the conversion rate for the general population may be further evaluated. Thereafter, comparing the three conversion rates may provide an improved metric to evaluate lift. For example, the difference between the conversion rate for the exposed group and the conversion rate for the unexposed group may be more significant when evaluating lift than by looking at the difference between the conversion rate of the exposed group and the general population. As such, lift may be determined by looking at the conversion rates of targeted, specific groups of users.

The illustrated embodiment further includes a potential exposure group 308, which is a subset of the unexposed group 306. The potential exposure group 308 includes users that were not exposed to the supplemental content, but that had a likelihood of being exposed based at least in part on their prior viewership history. For example, the potential exposure group 308 may include users who watch a particular program regularly, but who may have missed a particular episode during which the supplemental content was deployed. Furthermore, in various embodiments, the potential exposure group 308 may include users that would likely enjoy a certain type of programming or particular program based on their prior history. For example, a different program may be produced by the same production company, include the same actors, have the same writers, or the like, as another program that has been watched by a user. Accordingly, it may be inferred that the users may share at least some characteristics due to their similar tastes in content, and therefore these users may be evaluated as a group that may be likely to lead to some conversion event, even without direct exposure to the supplemental content. As will be described below, the potential exposure group 308 may be derived from a machine learning based analysis of the likelihood of a viewer being exposed to supplemental content.

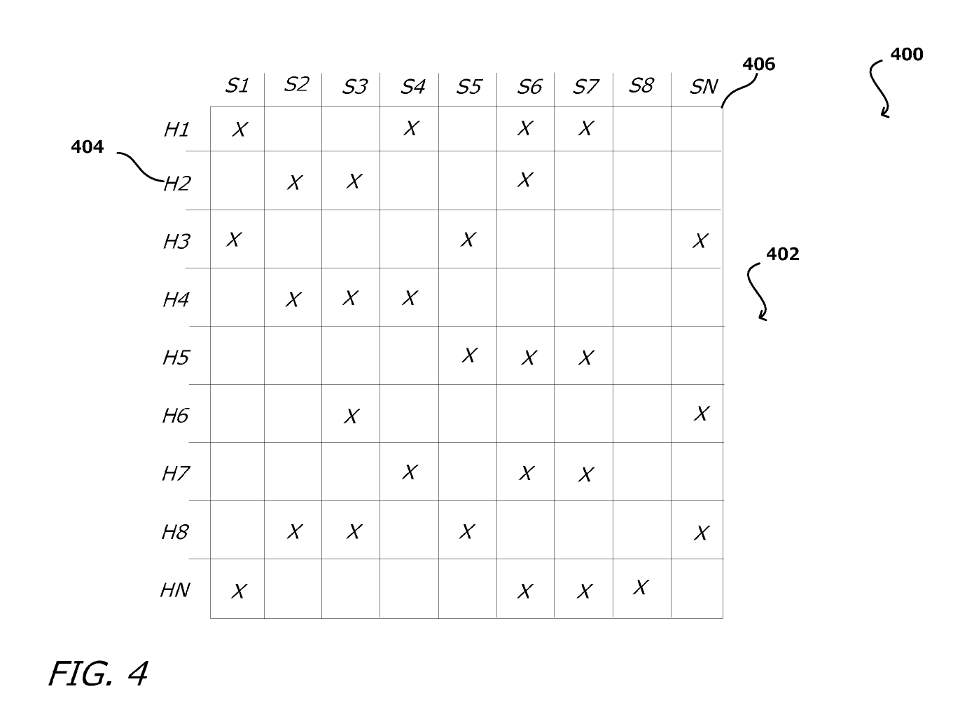

FIG. 4 illustrates an example machine learning method that may be utilized to generate a potential exposure score. The example system 400 includes a matrix 402 that categorizes households 404 (represented by “H”) as the rows and shows 406 (represented by “S”) as the columns. As shown, the households and shows go from 1 to N, which N representing any number that may be utilized to form the matrix 402. It should be appreciated that the columns and rows may be switched.

As described above, a set of potential exposures may be developed based at least in part on viewership histories associated with households and/or users. For example, a set of shows (S) may be selected where at least some number of households (H) had seen particular supplemental content. Any number of shows or households may be selected, based on parameters selected by the content provider in order to tune or otherwise adjust the accuracy. For example, at least 1,000 (one thousand), 1,500 (fifteen hundred), 2,000 (two thousand), or any reasonable number of exposed households may be selected. Furthermore, a time period for a particular network may be selected, such as an hour-long segment, which may include a number of different shows. The illustrated embodiment incorporates a matrix factorization model using Alternate Least Squares. As illustrated, squares that include the “X” may indicate a show or supplemental content seen by the household. Blank squares may indicate that the show or supplemental content has not been seen, but a likelihood of viewing that show may be identified through machine learning models. As the matrix 402 is populated and solved, scores for each unexposed household may be provided to develop the potential exposure group.

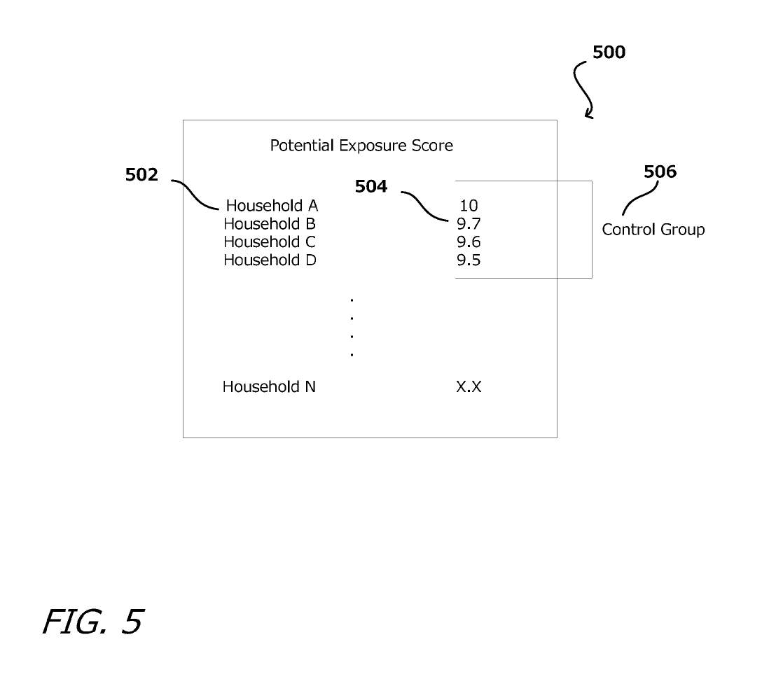

FIG. 5 illustrates an example list 500 of the households that have been grouped into the potential exposure group. In the illustrated embodiment, the households 502 associated with the potential exposure group are ranked based on their potential exposure score 504, illustrated as a numerical value in FIG. 5. It should be appreciated that the values associated with potential exposure are for illustrative purposes only and that, in other embodiments, the values may not be whole numbers, may not include decimal points, and the like. Further, the potential exposure score may be a binary score, where 1 indicates a likelihood of potential exposure above a threshold amount and 0 indicates a likelihood of potential exposure below a threshold amount. The scores illustrated in FIG. 5 may be aggregated in various ways. For example, all of the potential exposures for a household may be summed. Additionally, in various embodiments, the maximum potential exposure for a household may be used. The scores 504 provide an indication of how likely each unexposed household 502 was to have been exposed to supplemental content during a period of time. Households with higher scores are more likely to have been exposed to supplemental content, but for some reasons, were not. As described above, this may occur for various reasons, such as the household missed a particular episode of a show or the household watched the show in a time-shifted manner and fast-forwarded through the supplemental content.

In the illustrated embodiment, the households 502 are ranked according to their score 504, with higher scores being ranked above lower scores. As shown, the illustrated households 502 are labeled as A, B, C, and D and continuing to N, which indicates any number of households 502 which may be included within the rankings. Upon ranking the households 502, a control group 506 is selected. In various embodiments, the control group 506 may represent a certain percentage of the households 502, which may be households 502 having the highest scores 504. The number of households 502 to select for the control group 506 may vary and could be a standard number, a percentage, or a variable amount based on a variety of other factors, such as the size of the list, the difference between the score values, and the like. A tighter control group 506 (e.g., smaller number of households) may provide higher accuracy but may be too small of a sample size, based on the number of households. A larger control group 506 may provide a larger number of households for a broader, more general analysis.

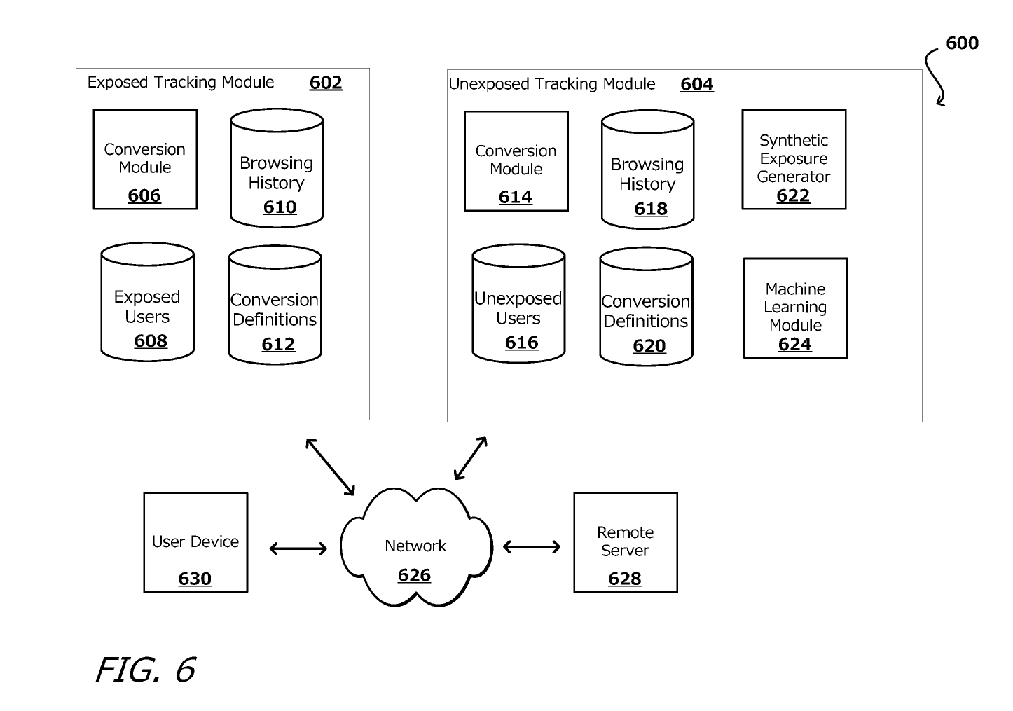

FIG. 6 illustrates a system 600 for tracking conversions and generating synthetic exposure events. It should be appreciated that, in various embodiments, different modules or features may be illustrated as separate, but may be integrated into single components. The system 600 includes an exposed tracking module 602 and an unexposed tracking module 604. The exposed tracking module 602 may be utilized to track conversion rates or the like for the households that were previously designated as being exposed to the supplemental content. The illustrated exposed tracking module 602 includes a conversion model 606, which may record conversion occurrences, such as clicks on a link or purchases. In various embodiments, the conversion module 606 receives information from other sources to track conversion events for users. For example, an exposed user database 608 may aggregate each user and/or household that has been exposed to one or more forms of supplemental content. Additionally, the browsing history database 610, as described above, may track online or other activity for a user or household, which may be based on an IP address, device identifier, cookie, or the like. Accordingly, after exposure to supplemental content, the user's browsing history may be monitored for conversion events for a predetermined period of time. The period of time may be defined in a conversion definition database 612, which may include definitions for conversions for a variety of content providers. For example, for some content providers a conversion may be navigating to a website. For others, a conversion may be purchasing product or watching a different television program. Accordingly, these definitions may be referenced by the conversion module 606 when determining whether or not a conversion has occurred. As a result, a conversion rate for supplemental content may be determined by calculating the number of conversions per number of exposed users. In this manner, content providers can measure the success of their supplemental content.

In various embodiments, the unexposed tracking module 604 tracks conversion rates for unexposed users/households and/or generates synthetic exposure events. In the illustrated embodiment, the unexposed tracking module 604 includes a conversion module 614, which in embodiments may be the same conversion module 606 utilized by the exposed tracking module 602. The conversion module 614 may record conversion events related to particular users or households. The unexposed tracking module 604 further includes an unexposed user database 616. This database 616 may include the unexposed group, the potential exposure group, and/or the control group. As described above, browsing history for the users in the database 616 may be monitored via the browsing history database 618. For example, the browsing history database 618 may track activity linked to an IP address such that activity can be tracked across multiple devices. Furthermore, the illustrated module 604 includes a conversion definitions database 620. This database 620 may include definitions for what is considered a conversion by a content provider, as described above.

In various embodiments, the unexposed tracking module 604 includes a synthetic exposure generator 622. This generator may develop and deploy synthetic exposure events to unexposed users, such as the control group. The events may be related to the group's viewership scores and/or viewership history. Furthermore, the events may be related to demographic information for the consumers. Accordingly, the synthetic exposure generator 622 enables a direct comparison, over a predetermined period of time, for conversions between the exposed group and the unexposed group. For example, the control group may be selected and a date or range of dates may be selected as the synthetic exposure. Thereafter, the user's activity may be tracked, via the conversion module 614, to determine whether a conversion takes place, even without exposure to the supplemental content. As such, the determined conversion rate may be compared to the conversion rate associated with the exposed group. The difference between the conversion rates may more accurately reflect the lift from the supplemental content because it would evaluate whether similar users would convert in the absence of viewing the supplemental content.

The illustrated embodiment also includes a machine learning module 624. The machine learning module 624, as described above, may include any number of machine learning or artificial intelligence techniques, such as neural networks, in order to develop synthetic exposures, choose the control groups, or the like. For example, the machine learning module 624 may develop different control groups and synthetic exposures based on a variety of factors, such as time of year of viewing, number of touches, etc. Furthermore, the machine learning module 624 may be utilized to refine the synthetic exposures or to deploy synthetic exposures before content providers launch supplemental content. In various embodiments, the synthetic exposures may enable content providers to predict the lift associated with supplemental content. Further, it may allow content providers to determine whether to produce supplemental content. For example, if the synthetic exposure event shows a high conversion rate, even in the absence of supplemental content, the content provider may determine that their market penetration is sufficient to not need additional supplemental content.

In various embodiments, the respective modules 602, 604 may be communicatively coupled to a network 626, which may be an Internet network as described above. The network 626 may further be connected to a remote server 628, as described above. Further, it should be appreciated that the modules 602, 604 may be incorporated into the remote server 628. As illustrated, the remote sever 628 may further receive information from the user device 630, which may also be communicatively coupled to the network 626.

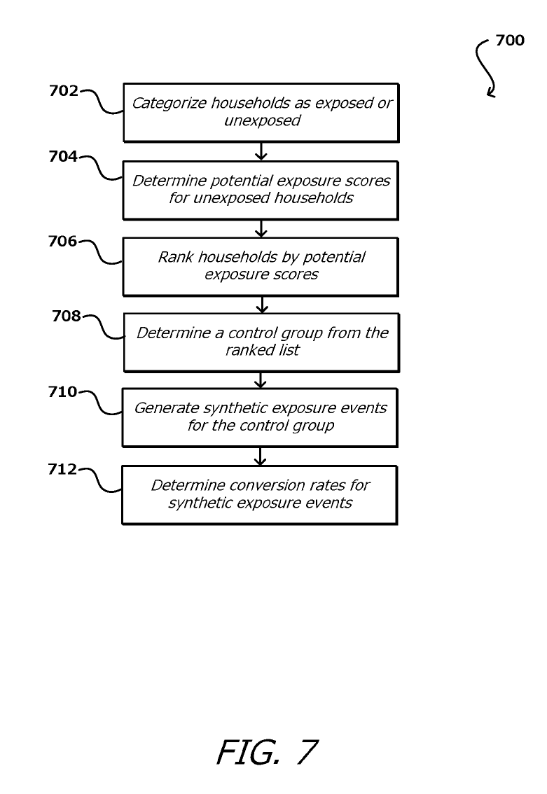

FIG. 7 is a flow chart representing a method 700 for determining synthetic conversion rates. As described above, synthetic conversion rates may enable accurate evaluations of lift from supplemental content by determining whether users having similar characteristics as users exposed to supplemental content would also have similar conversion rates. The method 700 includes categorizing households and/or users as exposed or unexposed 702. As should be understood, exposed consumers will be provided knowledge of the product or service in the supplemental content while unexposed consumers presumably have not been provided with the same exposure or information. Potential exposure scores 704 may be calculated for unexposed households. The potential exposure score may provide insight into the likelihood that a household or user would have been exposed to the supplemental content, but for some reason was not. For example, the household may have missed an episode of a program they enjoyed or skipped supplemental content.

Households may be ranked based on the calculated potential exposure scores 706. For example, larger scores may be ranked higher than lower scores, indicating a higher likelihood of exposure for households at the top of the list. From this list, a control group may be selected 708. In various embodiments, the control group may be a predetermined number or percentage of the list of unexposed households. However, in other embodiments, the control group may be related to the potential exposure scores, in which each household with a score greater than a threshold amount is sorted into the control group. The control group may represent a group of households with a high likelihood of potentially being exposed to supplemental content. This likelihood may correspond to the household's previous viewing history, demographic information, browsing history, or the like.

The method 700 further includes generating synthetic exposure events for the control group 710. The synthetic exposure events may be simulations of exposure events for the control group. For example, the synthetic exposure events may be selecting a date or a period of time to monitor the control group for conversion events related to supplemental content. While the households in the control group may not have been exposed to the supplemental content, they may be evaluated over the same period of time and under the same conditions as the exposed group. Accordingly, the comparison between the groups may be improved because data is evaluated over the same period of time and using the same criteria (e.g., clicks, views, etc.). Thereafter, conversion rates for the synthetic exposure events are determined 712. Conversion rates may be calculated as a function of the conversion events over the number of users. Furthermore, conversion events may be predefined and change different types of supplemental content based on preferences from content providers. Conversion rates may be monitored by evaluating users' browsing or purchasing patterns based on their IP addresses. Furthermore, ACR may be utilized to determine if the household watches other content, which may have been associated with supplemental content. In this manner, synthetic conversion rates may be calculated.

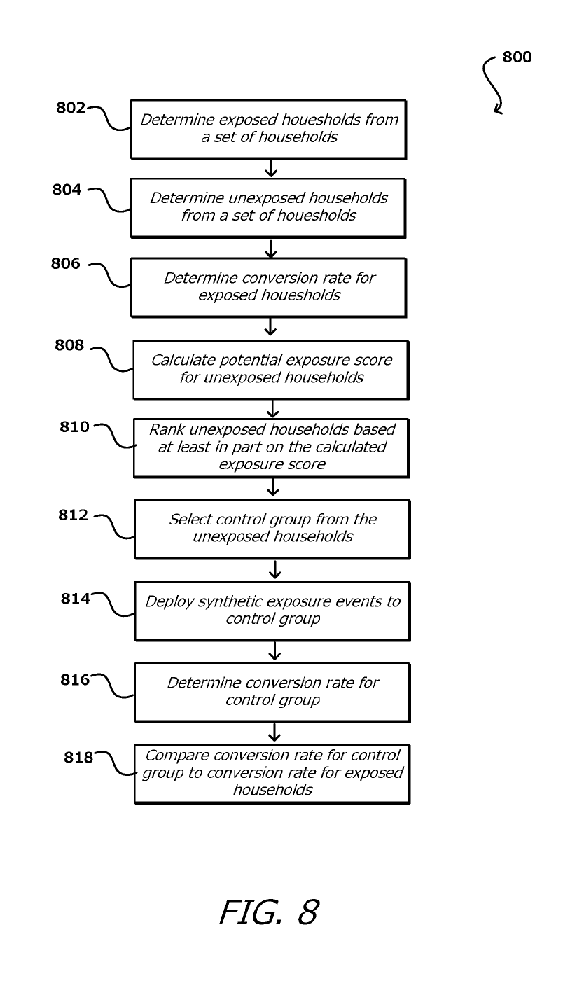

FIG. 8 is a flow chart representing a method 800 for comparing conversion rates between exposed and unexposed groups. The method 800 includes determining exposed households from a set of households 802. Exposure may be related to viewing or otherwise interacting with supplemental content, such as a commercial during a television series, supplemental content before a movie, or product placement, among others. As was described above, exposure may be linked to a time period for viewing the supplemental content or other metric. The method 800 continues by determining unexposed households from a set of households 804, which may be the same set of households described with respect to the exposed households. The unexposed households may be households that have not interacted with certain supplemental content through viewing via a user device. Conversions rates may be determined for the exposed households 806, for example by tracking later browsing history or purchase activity to determine whether households have navigated to webpages or have purchased certain products. As a result, content providers may evaluate the effectiveness, or lift, of their supplemental content.

The method 800 may also include calculating potential exposure scores for unexposed households 808. Potential exposure may be determined by evaluating prior viewing or browsing information for households or individual users. The score may be indicative of the likelihood that the household would see the supplemental content, but for some reason has not, such as because an episode of a series was missed or the supplemental content was not viewed due to time-shifted viewing or viewing through a streaming service that does not incorporate supplemental content. The calculated scores may enable ranking of the unexposed households 810. The households may be ranked from those most likely to have been exposed to those least likely. From this list, a control group may be selected 812. The control group may include the households with the highest scores, which may be determined by a variety of metric such as threshold amounts, percentages, predetermined numbers of households, and the like.

When control groups have been selected, synthetic exposure events may be deployed and directed toward the households in the control group 814. In various embodiments, the synthetic exposure events may include selecting a period of time to monitor other activity of the households, such as browsing histories or later viewership. During the period of time specified for the synthetic exposure event, a conversion rate may be determined for the control group 816. The conversion rate may be determined in a similar manner to those described above. In various embodiments, the conversion rate of the control group is compared to the conversion rate of the exposed households. This comparison provides an improved evaluation of the lift associated with the supplemental content. For example, the households in the control group may share similarities with the households in the exposed group, for example similar tastes in content. These similar tastes may further be tied to other demographic information, such as age or geographic location. As a result, content providers can directly evaluate how their supplemental content impacts users with potentially similar tastes, thereby better describing the lift than comparing the effect of the supplemental content against a general, randomly selected segment of the population.

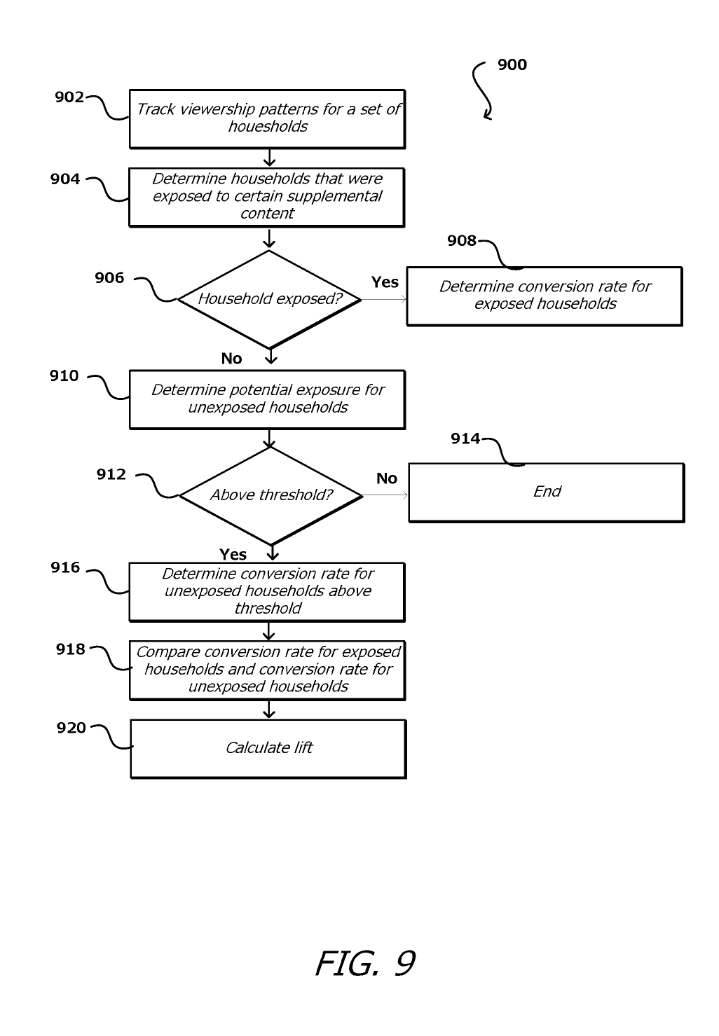

FIG. 9 is a flow chart representing method 900 for comparing conversion rates between different groups of households. In various embodiments, viewership information for a set of households is tracked 902. For example, ACR technology may be utilized to identify content consumed by a household or user devices within a household. In various embodiments, the tracking is related to a household in general, for example via IP identification, or tracking may be on a device-by-device or user-by-user basis. The method 900 identifies households that were exposed to supplemental content 904. As described in detail above, exposure may relate to the household viewing supplemental content or otherwise interacting with supplemental content. Next, the method 900 determines whether the household was exposed 906. As described above, in various embodiments merely viewing supplemental content may be inadequate to qualify as exposure under certain exposure criteria. If the household has been exposed, then a conversion rate is determined for the exposed household 908. If the household has not been exposed, then a potential exposure is determined 910. Potential exposure may be correlated to a numeric value determined, at least in part, by prior viewership history, demographics, or the like. The potential exposure value may be calculated and then compared against a threshold 912. If the value is below the threshold the method ends 914. If the value is above the threshold, then a conversion rate is determined for the unexposed households 916. In various embodiments, the conversion rate for unexposed households 916 is determined via a synthetic exposure event. The synthetic exposure event may incorporate evaluation of conversion activity for the unexposed households within a same period of time or under same conditions as the conversion rate for the exposed households.

In various embodiments, the conversion rate of the exposed households is compared to the conversion rate of the unexposed households 918. As described above, exposure criteria may be the same for both the exposed and unexposed households, and as a result the comparison may be considered normalized or otherwise equal because the difference between the two conversion rates is whether or not the supplemental content was viewed. Thereafter, the lift for the supplemental content is determined 920. In various embodiments, the lift may be the difference between the conversion rate of the exposed households and the conversion rate of the unexposed households. Accordingly, content providers can view the effectiveness of their supplemental content over a range or group of households, which may have some overlapping interests, rather than evaluating the difference over a random sampling of the population.

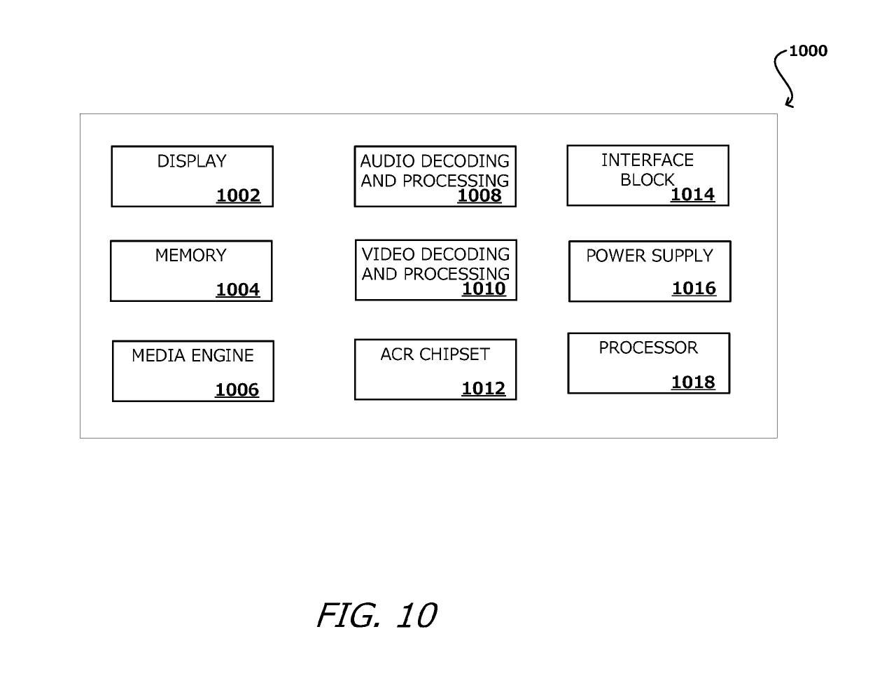

FIG. 10 illustrates an example user device 1000, which may include display elements (e.g., display screens or projectors) for displaying consumer content. In various embodiments, the user device 1000 may be a television, smartphone, computer, or the like as described in detail above. In various embodiments, the illustrated user device 1000 includes a display 1002. As will be appreciated, the display may enable the viewing of content on the user device 1000. The display may be of a variety of types, such as liquid crystal, light emitting diode, plasma, electroluminescent, organic light emitting diode, quantum dot light emitting diodes, electronic paper, active-matrix organic light-emitting diode, and the like. The user device 1000 further includes a memory 1004. As would be apparent to one of ordinary skill in the art, the device can include many types of memory, data storage, or computer-readable media, such as a first data storage for program instructions for execution by the at least one processor.

In various embodiments, the user device 1000 includes a media engine 1006. As used herein, the media engine 1006 may include an integrated chipset or stored code to enable the application of various media via the user device 1000. For example, the media engine 1006 may include a user interface that the user interacts with when operating the user device 1000. Further, the media interface 1006 may enable interaction with various programs or applications, which may be stored on the memory 1004. For example, the memory 1004 may include various third-party applications or programs that facilitate content delivery and display via the user device 1000.

In various embodiments, the user device 1000 further includes an audio decoding and processing module 1008. The audio decoding and processing module 1008 may further include speakers or other devices to project sound associated with the content displayed via the user device 1000. Audio processing may include various processing features to enhance or otherwise adjust the user's auditory experience with the user device 1000. For example, the audio processing may include feature such as surround-sound virtualization, bass enhancements, and the like. It should be appreciated that the audio decoding and processing module 1008 may include various amplifiers, switches, transistors, and the like in order to control audio output. Users may be able to interact with the audio decoding and processing module 1008 to manually make adjustments, such as increasing volume.

The illustrated embodiment further includes the video decoding and processing module 1010. In various embodiments, the video decoding and processing module 1010 includes components and algorithms to support multiple ATSC DTV formats, NTSC and PAL decoding, various inputs such as HDMI, composite, and S-Video inputs, and 2D adaptive filtering. Further, high definition and 3D adaptive filtering may also be supported via the video decoding and processing module 1010. The video decoding and processing module 1010 may include various performance characteristics, such as synchronization, blanking, and hosting of CPU interrupt and programmable logic I/O signals. Furthermore, the video decoding and processing module 1010 may support input from a variety of high definition inputs, such as High Definition Media Interface and also receive information from streaming services, which may be distributed via an Internet network.

As described above, the illustrated user device 1000 includes the ACR chipset 1012, which enables an integrated ACR service to operate within the user device 1000. In various embodiments, the ACR chipset 1012 enables identification of content displayed on the user device 1000 by video, audio, or watermark cues that are matched to a source database for reference and verification. In various embodiments, the ACR chipset 1012 may include fingerprinting to facilitate content matching. The illustrated interface block 1014 may include a variety of audio and/or video inputs, such as via a High Definition Media Interface, DVI, S-Video, VGA, or the like. Additionally, the interface block 1014 may include a wired or wireless Internet receiver. In various embodiments, the user device 1000 further includes a power supply 1016, which may include a receiver for power from an electrical outlet, a battery pack, various converters, and the like. The user device 1000 further includes a processor 1018 for executing instructions that can be stored on the memory 1004.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method, comprising:
receiving exposure data for a set of households, the exposure data comprising supplemental content associated with media content;
determining an exposed set of households from the set of households, the exposed set of households corresponding to households of the set of households that have been exposed to the supplemental content;
determining an unexposed set of households from the set of households, the unexposed set of household corresponding to households of the set of households that have not been exposed to the supplemental content;
determining a potential exposure score for the unexposed set of households, the exposure score corresponding to a likelihood of exposure to the supplemental content;
forming a control group from the unexposed set of households based at least in part on the exposure score;
generating a synthetic exposure event for the control group, the synthetic exposure event corresponding to a period of time associated with the supplemental content and subsequent interactions based at least in part on the supplemental content; and
determining a conversion rate for the control group, the conversion rate associated with interactions related to the supplemental content.

2. The method of claim 1, further comprising:
ranking the unexposed set households by exposure score; and
selecting unexposed households for the control group when the exposure score is greater than a threshold.

3. The method of claim 1, further comprising:
determining a conversion rate for the exposed set of households; and
comparing the conversion rate for the exposed set of households to the conversion rate for the control group.

4. The method of claim 1, further comprising:
determining a conversion rate for a population sample; and
comparing the conversion rate for the population sample to the conversion rate for the control group.

5. The method of claim 1, further comprising:
obtaining a browsing history for each unexposed household; and
calculating the conversion rate for each unexposed household based at least in part on the browsing history.

6. The method of claim 1, further comprising:
obtaining a viewership history for each unexposed household;
comparing the viewership history to the media content associated with the supplemental content; and
determining the potential exposure score based at least in part on a correlation between the viewership history and the media content.

7. A computing device, comprising:
a microprocessor; and
memory including instructions that, when executed by the microprocessor, cause the computing device to:
obtain viewership data corresponding to content consumed by a plurality of users, the content including supplemental content;
determine a group of users from the plurality of users that have not been exposed to the supplemental content;
determine a likelihood of exposure to the supplemental content for the group of users; and
determine a conversion rate associated with the supplemental content for a subset of users from the group of users with a likelihood above a threshold.

8. The computing device of claim 7, wherein the memory includes instructions that, when executed by the microprocessor, further cause the computing device to:
determine a second group of users from the plurality of users that have been exposed to the supplemental content; and
determine a conversion rate associated with the supplemental content for the second group of users.

9. The computing device of claim 8, wherein the memory includes instructions that, when executed by the microprocessor, further cause the computing device to:
compare the conversion rate for the subset of users to the conversion rate for the second group.

10. The computing device of claim 7, wherein the memory includes instructions that, when executed by the microprocessor, further cause the computing device to:
determine the likelihood of exposure using at least past viewership history for the group of users; and
rank the group of users by the likelihood, wherein users from the group of users with a higher likelihood are ranked higher.

11. The computing device of claim 7, wherein the memory includes instructions that, when executed by the microprocessor, further cause the computing device to:
generate a synthetic exposure event for the subset of the group of users, the synthetic exposure event measuring conversion over a period of time; and
determine the conversion rate for the subset of the group of users based at least in part on the synthetic exposure event.

12. The computing device of claim 7, wherein the memory includes instructions that, when executed by the microprocessor, further cause the computing device to:
obtain a browsing history for each user of the subset of users, wherein the conversion rate for the subset of users is calculated based at least in part on the browsing history.

13. A method, comprising:
obtaining viewership data corresponding to content consumed by a plurality of users, the content including supplemental content;
determining a group of users from the plurality of users that have not been exposed to the supplemental content;
determining a likelihood of exposure to the supplemental content for the group of users; and
determining a conversion rate associated with the supplemental content for a subset of users from the group of users with a likelihood above a threshold.

14. The method of claim 13, further comprising:
determining a second group of users from the plurality of users that have been exposed to the supplemental content;
determining a conversion rate associated with the supplemental content for the second group of users; and
comparing the conversion rate for the subset of users to the conversion rate for the second group.

15. The method of claim 13, further comprising:
determining the likelihood of exposure using at least past viewership history for the group of users; and
ranking the group of users by the likelihood, wherein users from the group of users with a higher likelihood are ranked higher.

16. The method of claim 13, further comprising:
generating a synthetic exposure event for the subset of the group of users, the synthetic exposure event measuring conversion over a period of time; and
determining the conversion rate for the subset of the group of users based at least in part on the synthetic exposure event.

17. The method of claim 16, wherein the synthetic exposure event corresponds to a period of time where conversions for the supplemental content are monitored.

18. The method of claim 13, wherein the likelihood of exposure is calculated using a matrix factorization model using alternate least squares.

19. The method of claim 13, wherein the threshold is determined by at least one of a predetermined number of users, a base likelihood value, and a percentage of the group of users.

20. The method of claim 13, further comprising:
selecting a third group of users from a general population;
determining a conversion rate for the third group; and
comparing the conversion rate for the third group to the conversion rate for the subset.
